(19) United States
(12) Patent Application Publication
(10) Pub. No.: US 2018/0288202 A1
(43) Pub. Date: Oct. 4, 2018

(54) COMPLEX DEVICE AND ELECTRONIC DEVICE COMPRISING SAME

(71) Applicant: MODA-INNOCHIPS CO., LTD., Ansan-si, Gyeonggi-do (KR)

(72) Inventors: Sung Chol PARK, Ansan-Si, Gyeonggi-Do (KR); Young Sul KIM, Seoul (KR); Yu Hyeong LEE, Hwaseong-Si, Gyeonggi-Do (KR); In Seob JEONG, Ansan-Si, Gyeonggi-Do (KR); Wan PARK, Ansan-Si, Gyeonggi-Do (KR)

(21) Appl. No.: 15/781,116

(22) PCT Filed: Dec. 13, 2016
(86) PCT No.: PCT/KR2016/014582

§ 371 Date: Jun. 1, 2018

(30) Foreign Application Priority Data
Dec. 24, 2015 (KR) 10-2015-0186690
Nov. 30, 2016 (KR) 10-2016-0161830

(51) Int. Cl. H04M 1/02; B06B 1/06; H04R 17/00

(52) U.S. Cl. CPC H04M 1/026; B06B 1/06; H04R 2499/11; H04R 2400/03; H04R 2400/11; H04R 17/00

(57) ABSTRACT

Provided is a complex device including: a frame in which a predetermined space is provided; a vibration member provided in the frame and generating vibration; and a speaker provided in the frame and generating a sound.

### TECHNICAL FIELD

The present disclosure relates to a complex device, and more particularly, to a complex device in which at least two functional parts different from each other are combined and an electronic device having the complex device.

### BACKGROUND ART

Touch screens are used in electronic devices such as a smart phone adopting a display. Due to the growing market of the electronic device, products using touch screens are increased, and the market is growing rapidly.

Furthermore, electronic devices have been developed to have a multifunction. Accordingly, two or more components different from each other may be included in an electronic device. For example, a speaker for outputting a sound from an electronic device and a vibration generation device for providing a feedback in response to a touch on a touch screen is demanded.

The vibration generating device is applied to a touch screen and thereby, enables a user to instantaneously sense a feedback vibration with respect to a touch input of a user. That is, the vibration generating device provided in a touch screen apparatus may be used as a means for a haptic feedback responding to a touch of a user with a vibration. The haptic feedback refers to a haptic sense which may be sensed through a finger tip (finger tip or stylus pen) of a user when the user touches an object. A haptic feedback means, which can recover a dynamic characteristic (vibration and haptic sense which are transferred to a finger when pushing a button by the finger, operation sound, or the like) with a responsibility similar to that in case of touching a real object (real button) when a person touches a virtual object (for example, button mark in a touch screen), can be said most ideal Accordingly, the vibration generating devices are required to provide a vibration force sufficient for a person to sense vibration through a haptic sense. Vibration motors, linear motors, or the like may be used as a vibration generating device applied to the touch screen apparatuses, and a piezoelectric vibration device may also be used.

Furthermore, a speaker may be provided to output a sound generated from an electronic device. A dynamic speaker or a piezoelectric speaker may be used as a speaker.

Meanwhile, since at least two or more devices which serve functions different from each other are provided, the mounting area is increased. That is, as the sizes of electronic devices are decreased, at least two or more devices are provided and a mounting area is thereby increased. Thus, it is impossible to respond to the miniaturization of electronic devices.

### PRIOR ART DOCUMENTS

(Patent document 1) Korean Patent Application Laid-open Publication No. 2014-0133658

### DISCLOSURE

### Technical Problem

The present disclosure provides a complex device in which at least two or more functions are combined.

The present disclosure also provides a complex device in which a speaker and a vibration generating device are combined into one.

The present disclosure also provides an electronic device provided with the complex device.

### Technical Solution

In accordance with an exemplary embodiment, a complex device includes: a frame in which a predetermined space is provided; a vibration member provided in the frame and generating vibration; and a speaker provided in the frame and generating a sound.

The vibration member may include a piezoelectric vibration member, and the speaker comprises a piezoelectric speaker.

The frame may include first, second, and third covers respectively covering upper, side, and lower parts thereof, wherein the second cover may include at least one inwardly protruding protrusion part.

The piezoelectric vibration member and the piezoelectric speaker may be provided with the protrusion part disposed therebetween.

The piezoelectric vibration member may include a first vibration plate and a first piezoelectric plate provided on one surface of the first vibration plate, wherein at least a portion of the first vibration plate may be provided on the protrusion part.

The piezoelectric vibration member may further include a connecting member provided between the other surface of the first vibration plate and the first cover, and the first cover may be used as a weight body of the piezoelectric vibration member.

The piezoelectric vibration member and the piezoelectric speaker may be provided to be brought into contact with each other.

The piezoelectric vibration member may further include a connecting member provided between the other surface of the first vibration plate and the piezoelectric speaker, and the piezoelectric speaker may be used as a weight body of the piezoelectric vibration member.

The piezoelectric speaker may include a second vibration plate, a second piezoelectric plate provided on one surface of the second vibration plate; a PCB provided on one surface of the second vibration plate so as to be spaced apart from the second piezoelectric plate; and a lid member provided on the PCB.

The first vibration plate and the second vibration plate may be provided to be formed of materials different from each other, and the first vibration plate may be thicker than the second vibration plate.

The first piezoelectric plate and the second piezoelectric plate may be provided to have the same structure and material, and the first piezoelectric plate may be thicker than the second piezoelectric plate.

The complex device may further include a waterproof layer formed on at least a portion of at least any one of the piezoelectric vibration member and the piezoelectric speaker.

The complex device may further include a pressure sensor provided inside or outside the frame.

The pressure sensor may include first and second electrode layers and a piezoelectric layer or a dielectric layer provided between the first and second electrode layers.

In accordance with another exemplary embodiment, an electronic device includes: a case; a window provided on an upper side in the case; a display part provided in the case and displaying an image through the window; and a complex device provided in the case and serving at least two or more functions, wherein the complex device includes a frame in which a predetermined space is provided, a vibration member provided in the frame and generating vibration, and a speaker provided in the frame and generating a sound.

The vibration member and the speaker may be provided to be spaced apart from each other, and a portion of the frame may be used as a weight body of the vibration member.

The vibration member and the speaker may be provided to be in contact with each other, and the speaker may be used as a weight body of the vibration member.

The electronic device may further include a pressure sensor provided inside or outside the frame.

### Advantageous Effects

In accordance with an exemplary embodiment, at least two or more distinct functions may be combined to implement a complex device. That is, a speaker for outputting sound and a vibration member for providing a haptic feedback may be combined into one to implement a complex device. In addition, a pressure sensor may be further combined in addition to the speaker and the vibration member to implement a complex device. A mounting area in an electronic device may be reduced by applying such complex devices to the electronic device, and thus, it is possible to quickly respond to the miniaturization of electronic devices.

### BRIEF DESCRIPTION OF THE DRAWINGS

FIG. 1 is a cross-sectional view of a complex device in accordance with a first exemplary embodiment;

FIG. 2 is a plan view of a first vibration plate in accordance with exemplary embodiments;

FIG. 3 is a cross-sectional view of a complex device in accordance with a second exemplary embodiment;

FIG. 4 is a cross-sectional view of a complex device in accordance with a third exemplary embodiment;

FIG. 5 is a cross-sectional view of a pressure sensor constituting a complex device in accordance with a third exemplary embodiment; and

FIGS. 6 and 7 are perspective views of an electronic device provided with a complex device in accordance with exemplary embodiments.

### MODE FOR CARRYING OUT THE INVENTION

Hereinafter, embodiments will be described in more detail with reference to the accompanying drawings. The present invention may, however, be embodied in different forms and should not be construed as limited to the embodiments set forth herein. Rather, these embodiments are provided so that this disclosure will be thorough and complete and will fully convey the scope of the present invention to those skilled in the art.

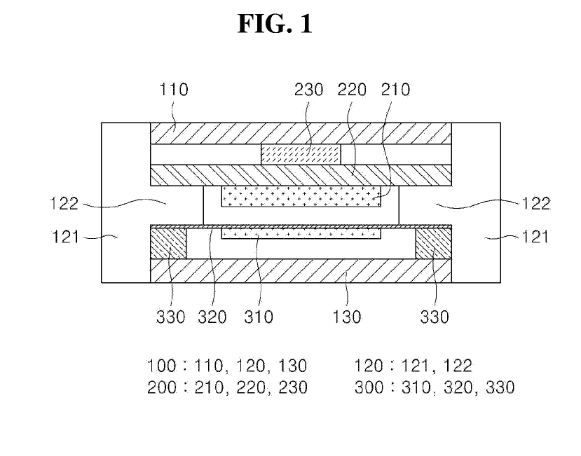

FIG. 1 is a cross-sectional view of a complex device in accordance with a first exemplary embodiment.

Referring to FIG. 1, a complex device in accordance with a first exemplary embodiment may include at least two or more functional parts which serve different functions. For example, the complex device may include a frame 100 and first and second components which are provided in the frame 100 and serve different functions. Here, each of the first and second parts may include a piezoelectric vibration member for providing a haptic feedback and a piezoelectric speaker for outputting a sound. Hereinafter, in accordance with a first exemplary embodiment, a complex device in which a piezoelectric vibration member 200 and a piezoelectric speaker 300 are combined.

1. Frame

A frame 100 provides a predetermined space therein and may include a first cover 110 for covering an upper portion thereof, a second cover 120 for covering a side surface thereof, and a third cover 130 for covering a lower portion thereof. That is, the frame 100 may cover the upper and lower portions, and side portions provided between the upper and lower portions and may provide a predetermined space therein.

The first cover 110 is provided so as to cover the upper surface of the complex device. In addition, the piezoelectric vibration member 200 may be positioned under the first cover 110. The first cover 110 may be provided to have a predetermined thickness and a plate shape. Also, the first cover 110 may have an approximately rectangular shape according to the shape of the complex device. However, the first cover 110 may be provided in various shapes, such as a circle, a square or polygon, according to the shape of the complex device. The first cover 110 may have an elastic modulus of approximately 1.97×10⁴ kg/cm2 to approximately 0.72×10⁶ kg/cm2. The first cover 110 may be formed by using various materials having the elastic modulus, for example, phosphor bronze, aluminum, stainless steel, plastic, or the like may be used. Also, the first cover 110 may use an alloy (63.5Fe, 36Ni, 0.5Mn) of iron and nickel, that is, INVAR. The first cover 110 may be formed in a thickness of, for example, approximately 0.1 mm to approximately 1 mm Meanwhile, the first cover 110 may be connected to the piezoelectric vibration member 200 through the connecting member 230 and may provide a weight to the piezoelectric vibration member 200 through the connecting member 230 to thereby function as a weight body for increasing the vibration force of the piezoelectric vibration member 200.

The second cover 120 covers the side surface of the complex device. The second cover 120 may be provided between the first and third covers 110 and 130 so as to perpendicularly cross, that is, perpendicular to the first and third covers 110 and 130. Here, the second cover 120 separates a space, in which the piezoelectric vibration member 200 and the piezoelectric speaker 300 are provided, to thereby support the piezoelectric vibration member 200 and the piezoelectric speaker 300. The second cover 120 may include a vertical part 121 vertically provided between the first and third covers 110 and 130, and a protrusion part 122 protruding inwardly from a predetermined region of the vertical part 121. The vertical part 121 and the protrusion part 122 of the second cover 120 may be formed in the same thickness or different thicknesses, and the vertical part 121 may have the thickness greater than the protrusion part 122. Also, the protrusion part 122 may have the thickness which can be adjusted according to the distance between the piezoelectric vibration member 200 and the piezoelectric speaker 300. As such, the protrusion part 122 is formed such that the second cover 120 inwardly protrudes, and the piezoelectric vibration member 200 and the piezoelectric speaker 300 are supported by one and the other surfaces of the protrusion part 122. In the second cover 120, the vertical part 121 may be formed in an approximately rectangular or circular frame shape according to the shape of the complex device, and the protrusion part 122 may be provided to protrude in at least two regions of the vertical part 121. That is, the vertical part 121 may be provided to have an opening in a central portion thereof and to surround an outer periphery of the complex device, and the protrusion part 122 may be formed on the entire inner periphery of the vertical part 121 or formed in two or more regions spaced a predetermined distance apart from each other. The second cover 120 may be formed of by using various materials according to an elastic modulus thereof. For example, the second cover 120 may have an elastic modulus of approximately 1.97×10⁴ to approximately 0.72×10⁶ kg/cm² and may be formed of phosphor bronze, stainless steel, INVAR, or the like. The second cover 120 may form the exterior shape of the complex device and may prevent the piezoelectric vibration member 200 and the piezoelectric speaker 300 from being released or damaged due to a shock. Meanwhile, the second cover 120 may have at least one cut or opened region, and a wiring part (not shown) may be introduced in the region. Also, in the second cover 120, the piezoelectric vibration member 200 may be inserted inside the vertical part 121 from one side of the vertical part 121 and the piezoelectric speaker 300 may be inserted from the other side. Accordingly, to facilitate the insertion and alignment of the piezoelectric vibration member 200 and the piezoelectric speaker 300, a guide pin or a guide groove may be formed in a predetermined region of the vertical part 121. For example, a predetermined groove is formed on the upper side and a lower side of the vertical part and a protrusion part is formed in a portion corresponding to the groove in the first and third covers 110 and 130, and thus, the piezoelectric vibration member 200 and the piezoelectric speaker 300 may be easily fastened inside the second cover 120. Meanwhile, the first and third covers 110 and 130 may be provided to contact the inner side of the vertical part 121 of the second cover 120 or may be provided such that at least one thereof may be spaced apart from the second cover 120. For example, another protrusion part (not shown) may be formed inside the vertical part 121 so that the first and third covers 110 and 130 are mounted, and side surfaces of the first and third covers 110 and 130 may be attached to the inner side surface of the vertical part 121 by using an adhesive. Meanwhile, since the first cover 110 may function as a weight body of the piezoelectric vibration member 200, the first cover 110 may not be attached or fastened to the second cover 120 but may also be supported by at least one region of the second cover 120.

The third cover 130 is provided on a lower side of the second cover so as to face the first cover 110. That is, the third cover 130 is provided so as to cover the lower surface of the complex device. The third cover 130 may be provided to have a predetermined thickness and a plate shape. Also, the third cover 130 may be provided in various shapes, such as a rectangle, a circle, a square or polygon, according to the shape of the complex device. For example, the third cover 130 may have an elastic modulus of approximately 1.97×10⁴ to approximately 0.72×10⁶ kg/cm² and may be formed of phosphor bronze, stainless steel, INVAR, or the like. Also, the third cover 130 may be formed in a thickness of approximately 0.1 mm to approximately 0.4 mm. Here, the third cover 130 may be formed thinner than the second cover 110 or may be formed in the same thickness as the first cover 110. Also, the third cover 130 may be formed in the same shape as the first cover 110. However, the third cover 130 may be formed in a thickness different from that of the first cover 110 and in a shape different from that of the first cover 110.

As described above, the frame 100 has a predetermined space therein such that the upper side thereof is covered by the first cover 110, the side surface thereof is covered by the second cover 120, and the lower side thereof is covered by the third cover 130. Meanwhile, the first cover 110 may be used as a weighting body of the piezoelectric vibration member 200 and therefore, may be provided thicker or heavier than the third cover 130.

2. Piezoelectric Vibration Member

A piezoelectric vibration member 200 may be provided in the space inside the frame 100 and may include a first piezoelectric plate 210, a first vibration plate 220 provided on one surface of the first piezoelectric plate 210, and a connecting member 230 provided on one surface of the first vibration plate 220.

The first piezoelectric plate 210 may be provided in, for example, a rectangular plate having a predetermined thickness. Of course, the first piezoelectric plate 210 may be provided not only in a rectangular shape but also in various shapes, such as circles, squares, or polygons. That is, the first piezoelectric plate 210 may have various shapes according to the shape of the complex device. The first piezoelectric plate 210 may include a substrate and a piezoelectric layer on at least one surface of which the substrate is formed. For example, the piezoelectric plate 210 may be formed in a bimorph type in which piezoelectric layers are formed on both surfaces of the substrate and may also be formed in a unimorph type in which a piezoelectric layer is formed on one surface of the substrate. The piezoelectric layer may be formed such that at least one layer is laminated or a plurality of piezoelectric layers are favorably laminated. Furthermore, electrodes may respectively be formed in upper and lower portions of the piezoelectric layer. That is, a plurality of piezoelectric layers and a plurality of electrodes may be alternately laminated to implement the first piezoelectric plate 210. Here, the piezoelectric layer may be formed by using piezoelectric materials, such as Pb, Zr, and Ti (PZT), Na, K and Nb (NKN), Bi, Na, and Ti (BNT), or a polymer based materials. Also, the piezoelectric layer may be formed by being laminated while being polarized in different directions different from each other or in the same direction. That is, when a plurality of piezoelectric layers are formed on one surface of the substrate, each piezoelectric layer may be alternately polarized in directions reverse to each other or in the same direction. Meanwhile, the substrate may be formed by using a material, which has a property of being capable of generating vibration while maintaining a structure in which piezoelectric layers are laminated, such as metal or plastic. However, the first piezoelectric plate 210 may not be formed by using a piezoelectric layer and a substrate. For example, the first piezoelectric plate 210 may be formed such that a non-polarized piezoelectric layer is provided on a central portion thereof, and a plurality of piezoelectric layers polarized in different directions are laminated in the upper and lower portions the non-polarized piezoelectric layer.

At least one portion of the first vibration plate 220 may be fixed to the frame 100. That is, the vibration plate 220 may have edges which have predetermined widths and which may be fixed on the protrusion part of the second cover 120 of the frame 100. Accordingly, the first vibration plate 220 may be fixed such that the edges thereof are fixed on the protrusion part and fastened by using screws or attached by using an adhesive. Since the piezoelectric vibration member 200, after being manufactured, may be fixed inside the frame 100, the first vibration plate 220 may be fixed by using an adhesive. However, the first vibration plate 220 may be fastened by using screws to thereby be firmly fixed even under a strong vibration, a shock, or thermal shock due to a high temperature. As such, the first vibration plate 220 is fixed to the frame 100, and the first piezoelectric plate 210 may be provided on one surface of the first vibration plate 220 which does not face the first cover 110 of the frame 100. For example, the first vibration plate 220 is fixed on the upper surface of the protrusion part, and the first piezoelectric plate 210 may be attached on a lower surface of the first vibration plate 220 in a region between the protrusion parts. Of course, the piezoelectric plate 310 may be attached by using an adhesive on the other surface of the first vibration plate 220 facing the first cover 110 of the frame 100. The first vibration plate 220 may be manufactured by using metal, plastic, or the like, or by using at least a dual structure in which materials different from each other are laminated. For example, the first vibration plate 220 may be formed of phosphor bronze, stainless steel, INVAR, or the like. Furthermore, the first vibration plate 220 may have an elastic modulus of approximately 1.97×10⁴ to 0.72×10⁶ kg/cm2. Here, the first piezoelectric plate 210 may be provided smaller than the first vibration plate 220. Also, the first vibration plate 220 may have a predetermined curvedly formed region except for the region to which the first piezoelectric plate 210 is attached. That is, in the first vibration plate 220, the portions outside the region to which the first piezoelectric plate 210 is attached may have a predetermined curvature, for example, may have a shape which is downwardly bent and then upwardly bent again. Furthermore, flat regions may be formed again outside the curved regions, and the flat regions may contact the frame 100. In other words, the first vibration plate 220 may be manufactured such that a first region contacting the first piezoelectric plate 210 and a second region contacting the frame 100 are provided in flat plate shapes, and curved third regions are provided between the first and second regions.

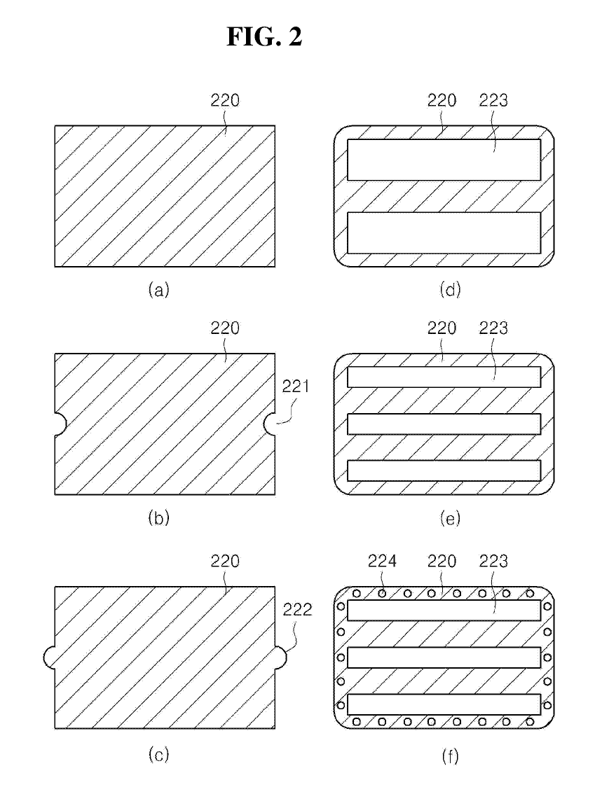

Meanwhile, the first vibration plate 220 may be provided in various shapes as illustrated in FIG. 2. That is, as illustrated in (a) of FIG. 2, the first vibration plate 220 may be provided in a rectangular plate shape having a predetermined thickness, and as illustrated in (b) of FIG. 2 or (c) of FIG. 2, one or more recess parts 221 or protrusion parts 222 may be formed in a predetermined regions of two facing sides, for example, in central portions of short sides. Here, protrusion parts or recess parts may be formed inside the vertical part 121 of the second cover 120 of the frame 100 corresponding to the recess parts 221 or the protrusion parts 222 of the first vibration plate 220. Accordingly, the recess parts 221 or the protrusion parts 222 of the first vibration plate 220 are inserted into the frame 100 by being fastened to the corresponding protrusion parts or recess parts inside the vertical part 121, and thus, the first vibration plate 220 may be more easily arranged and a process margin may thereby be improved. Also, as illustrated in (d) of FIG. 2 and (e) of FIG. 2, at least one or more openings 223 may be formed in the first vibration plate 220. The openings 223 may be formed such that at least one region of the first vibration plate 220 is removed or cut in the direction of the long sides having great lengths in the first vibration plate 220. As such, since at least one opening 223 is formed in the first vibration plate 220, the first piezoelectric plate 210 may have at least one region which is provided on the opening 223 without being attached to the first vibration plate 220. That is, the first vibration plate 220 has at least one portion contacting the first piezoelectric plate 210 and the remaining portions which do not contact the first piezoelectric plate 210. Of course, at least two or more first vibration plates 220 separated from each other and one first piezoelectric plate 210 may be provided and attached all together. Meanwhile, the first vibration plate 220 may have a plurality of holes 224 formed along edges thereof as illustrated in (f) of FIG. 2. The plurality of holes 224 may be provided to fasten screws to the first vibration plate 220. That is, screws or coupling pins may be fastened to the protrusion parts of the frame 100 through the plurality of holes 224.

The connecting member 230 is provided between the piezoelectric vibration member 200 and the frame 100. That is, the connecting member 230 may be provided between the first piezoelectric plate 220 of the piezoelectric vibration member 200 and the first cover 110. Meanwhile, the connecting member 230 may be provided in an approximately rectangular shape according to the shapes of the first vibration plate 220 and the first cover 110. However, the connecting member 230 may be formed in various shapes such as circles, squares, or polygons, and the shapes are not particularly limited. The connecting member 230 may be provided in a central portion of the first vibration plate 220 and may be formed in an area of approximately 5% to approximately 50% of the area of the first vibration plate 220. When the area of the connecting member 230 is greater than approximately 50% of that of the first vibration plate 220, the first vibration plate 220 may be suppressed from vibrating, and when area of the connecting member 230 is smaller than approximately 5% of that of the first vibration plate 220, the vibration of the first vibration plate 220 may not be properly transferred to the first cover 110 and thereby, the weight of the first cover 110 may not be properly loaded to the first vibration plate 220. Meanwhile, the connecting member 230 may be fixed to at least one of the piezoelectric vibration member 200 or the frame 100 through adhesion or other methods. For example, the connecting member 230 may be fixed to the piezoelectric member 230 to contact the frame 100 without being fixed to the frame 100 or may also be fixed to the frame 100 to contact the piezoelectric member 200 without being fixed to the piezoelectric member 200. However, the connecting member 230 may favorably be fixed to both the piezoelectric member 200 and the frame 100 in a stable manner Here, in order to attach the connecting member 230 to the piezoelectric vibration member 200 and the frame 100, an adhesive such as a double-sided tape may be used, and at this time, the adhesive such as a double-sided tape may be provided in a thickness of approximately 0.05 mm to approximately 1.0 mm. Of course, the connecting member 230 may be formed of adhesive materials such as rubber or silicone to thereby be attached for itself to the piezoelectric vibration member 200 and the frame 100. The connecting member 230 may be provided by using PET, polyurethane, polycarbonate, rubber, silicone, PORON, or the like. Also, the connecting member 230 may have a hardness of approximately 20 to approximately 90. For example, when the connecting member 230 is formed of polycarbonate of PET, the hardness may be approximately 50 to approximately 90, and when formed of silicone, the hardness may be approximately 45 to approximately 70, and when formed of PORON, the hardness may be approximately 20 to approximately 70. As such, when a product is dropped or shocked, damage to the product may be prevented by providing the connecting member 230. Also, vibration force may be transferred without loss by concentrating the vibration of the piezoelectric vibration member 300, and a voltage may be more easily outputted by concentrating force to the device side when a pressure is applied. In addition, the connecting member 230 function as a medium for increasing the vibration force of the piezoelectric vibration member 200 by transferring the weight of the first cover acting as a weight body to the piezoelectric vibration member 200.

Meanwhile, the piezoelectric vibration member 200 may have a waterproof layer (not shown) formed in at least a portion thereof. The waterproof layer may be coated by using a waterproof material, such as parylene. While the first piezoelectric plate 210 is bonded onto the first vibration plate 220, the waterproof layer may be formed on the upper and side surfaces of first piezoelectric plate 210 and on the upper and side surfaces of the first vibration plate 220 which is exposed by the first piezoelectric plate 210. That is, the waterproof layer may be formed on the upper and side surfaces of the first piezoelectric plate 210 and the first vibration plate 220. Also, while the first piezoelectric plate 210 is bonded onto the first vibration plate 220, the waterproof layer may be formed on the upper and side surfaces of first piezoelectric plate 210 and on the upper, side, and lower surfaces of the first vibration plate 220. That is, the waterproof layer may be formed on the upper, side, and lower surfaces of the first piezoelectric plate 210 and the first vibration plate 220. As such, since the waterproof layer is formed on at least one surface of the first piezoelectric plate 210 and the first vibration plate 220, moisture penetration into the piezoelectric vibration member 200 and oxidation of piezoelectric vibration member 200 may be prevented. Furthermore, a response speed may also be improved by increasing the hardness of the first vibration plate 220. In addition, a resonant frequency may be adjusted according to the coated thickness of parylene. Of course, the waterproof layer may also be applied only on the first piezoelectric plate 210, that is, may be applied on upper, side, and lower surfaces of the first piezoelectric plate 210. Alternatively, the waterproof layer may be applied on a power line such as an FPCB for supplying power to the first piezoelectric plate 210 by being connected to the first piezoelectric plate 210. Since the waterproof layer is formed on the first piezoelectric plate 210, the first piezoelectric plate 210 may be prevented from moisture penetration and oxidation. Furthermore, a resonant frequency may be adjusted by adjusting the forming thickness of the waterproof layer. Such a waterproof layer may be applied with a different thickness according to a material and a characteristic of the first piezoelectric plate 210 or the first vibration plate 220 and may be formed in a thickness smaller than the thickness of the first piezoelectric plate 210 or the first vibration plate 220, for example, formed in a thickness of approximately 0.1 μm to approximately 10 μm. In order to apply the waterproof layer as described above, for example, parylene is firstly heated to be vaporized into a dimmer state in a vaporizer, is then secondly heated to be thermally decomposed into a monomer state, and is then cooled to be converted into a polymer state, and may thus be applied on at least one surface of the piezoelectric vibration member 200. Meanwhile, the waterproof layer such as parylene may be formed on the connecting member 230 on the piezoelectric vibration member 200 and may also be formed on at least a portion of the frame 100.

3. Piezoelectric Speaker

A piezoelectric speaker 300 may include a second piezoelectric plate 310 and a second vibration plate 320 attached to one surface of the second piezoelectric plate 310.

The second piezoelectric plate 310 may be formed in the same manner as the first piezoelectric plate 210. That is, the second piezoelectric plate 310 may include a substrate and a piezoelectric layer having at least one surface on which the substrate is formed. Also, the content described on the first piezoelectric plate 210 may be applied to the second piezoelectric plate 310. However, the second piezoelectric plate 310 may be formed in a thickness equal to or smaller than the first piezoelectric plate 210. For example, the second piezoelectric plate 310 may be formed in a thickness of approximately 30% to approximately 100% of the thickness of the first piezoelectric plate 210. Meanwhile, an electrode pattern (not shown) to which a driving signal is applied may be formed on an upper portion of one surface of the second piezoelectric plate 310. At least two or more electrode patterns may be formed to be spaced apart from each other and may be connected to a connecting terminal (not shown) to thereby receive a sound signal from an electronic device, such as a mobile device, through the terminal.

The second vibration plate 320 may be provided in a plate shape, such as an approximate rectangle, a circle, or the like, having a predetermined thickness and may be greater than the second piezoelectric plate 310. The second vibration plate 320 may have an edge which may be attached onto one surface of the protrusion part of the second cover 120. That is, edges of the first vibration plate 220 are attached to the upper surface of the protrusion part of the second cover 120, and edges of the second vibration plate 320 may be attached to the lower surface of the protrusion part. The second vibration plate 320 may be formed of a material different from the first vibration plate 220. For example, the second vibration plate 320 may be formed of a polymer-based or a pulp-based material. For example, the second vibration plate 320 may be formed of a resin film, and specifically, may be formed of an ethylene propylene rubber based material, a stylene butadiene rubber based material, or the like which have Young' s modulus of approximately 1 MPa to approximately 10 GPa and a great loss factor. Also, the second vibration plate 320 may be formed to be smaller and thinner than the first vibration plate 220. That is, the first vibration plate 220 is formed such that edges thereof are attached to the upper surface of the protrusion part and a side surface thereof contact the inner side of the vertical part of the second cover 120, and the second vibration plate 320 is provided such that a side surface thereof is spaced apart from the inner side of the vertical part of the second cover 120. Also, since the first vibration plate 220 may be formed of metal or the like and the second vibration plate 320 is formed in a film, the second vibration plate 320 may be formed in a thickness smaller than the first second vibration plate 220. The piezoelectric speaker 300 may be driven in response to a predetermined signal and may output a sound having an excellent high sound characteristic.

Also, the piezoelectric speaker 300 may be provided with a PCB 330 for driving the piezoelectric speaker 300 on a lower side of the protrusion part. Also, the lower side of the PCB 330 may contact the third cover 130.

Meanwhile, the piezoelectric speaker 300 may further be provided with a waterproof layer (not shown) formed by using a waterproof material on at least a portion thereof. The waterproof layer may be formed on at least portions of the second piezoelectric plate 310 and the second vibration plate 320. That is, the waterproof layer applied to the piezoelectric speaker 300 may be formed on at least portions of the second piezoelectric plate 310 and the second vibration plate 320 like the waterproof layer applied to the piezoelectric vibration member 200.

Also, each of components constituting the complex device of the exemplary embodiment may be attached by using an adhesive member or the like. For example, the first and second piezoelectric plates 210 and 310 may be attached to the first and second vibration plates 220 and 320 by using an adhesive, and the first and second vibration plates 220 and 320 may be attached onto the protrusion part by using an adhesive. Also, the connection member 230 may be attached to at least one of the first cover 110 and the first vibration plate 220 by using an adhesive. However, the components may also be attached by various methods. For example, the components may be attached by using a metal-attached double-sided tape, by using epoxy, or by a method of welding or screw fastening.

As described above, the complex device in accordance with the first exemplary embodiment may be provided with the piezoelectric vibration member 200 for providing a haptic feedback and the piezoelectric speaker 300 for outputting a sound which are spaced apart a predetermined space in the frame 100. Accordingly, since two or more components which serve at least two or more functions are implemented in one complex device, the mounting area in an electronic device to which the complex device is applied may be reduced, and thus, it is possible to quickly respond to the decrease in sizes of the electronic devices.

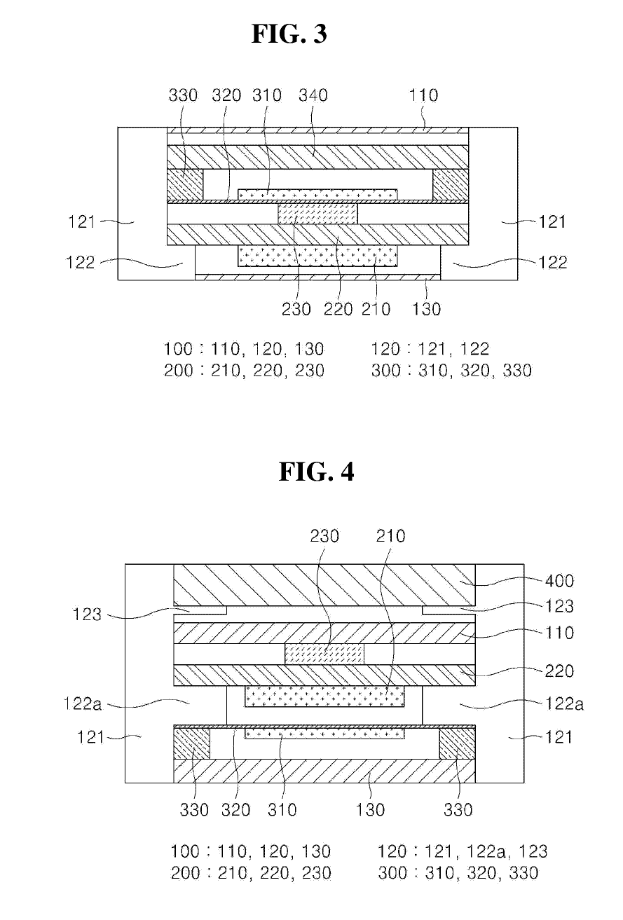

FIG. 3 is a cross-sectional view of a complex device in accordance with a second exemplary embodiment.

Referring to FIG. 3, a complex device in accordance with a second exemplary embodiment may include a frame 100, a piezoelectric vibration member 200 and a piezoelectric speaker 300 which are provided in the frame 100, wherein the piezoelectric speaker 300 is connected to a first vibration plate 220 of the piezoelectric vibration member 200 through a connecting member 230. That is, in another exemplary embodiment, the piezoelectric speaker 300 functions as a weight body of the piezoelectric vibration member 200.

The frame 100 includes a second cover 120 for covering a side surface thereof and a first and third covers 110 and 130 for covering the upper and lower portion of the second cover 120. Here, the second cover 120 may be provided with a vertical part 121 forming the side surface of the frame 100 and a protrusion part 122 by which and the piezoelectric vibration member 200 is supported, and the protrusion part 122 may be provided adjacent to the third cover 130. That is, the protrusion part 122 may be provided to have a predetermined height from a lower portion contacting the third cover 130. In the previous exemplary embodiment, the protrusion part 122 is provided on a central portion of the second cover 120, but in the second exemplary embodiment, the protrusion part 122 is provided on a lower side of the second cover 120.

The piezoelectric vibration member 200 may include: a first vibration plate 220 supported on the protrusion part 122 of the frame 100; a first piezoelectric plate 210 provided on one surface of the first vibration plate 220; and a connecting member 230 provided on the other surface of the first vibration plate 220. That is, the first piezoelectric plate 210 may be provided on the lower surface the first vibration plate 220 so as to face the third cover 130, and the connection member 230 may be provided on the upper surface of the first vibration plate 220 on which the first piezoelectric plate 210 is not provided.

The piezoelectric speaker 300 may include: a second vibration plate 320 provided on the connection member 230; a second piezoelectric plate 310 provided on the upper surface of the second vibration plate 320; a PCB 330 provided on the upper surface of the second vibration plate 320 so as to be spaced apart from the second piezoelectric plate 310; and a lid member 340 provided on the PCB 330 and spaced apart a predetermined distance from the second piezoelectric plate 310. That is, the PCB 330 may be provided to be higher than the second piezoelectric member 320, and the lid member 340 is provided on the PCB 330. Accordingly, a predetermined space is provided by the second vibration plate 320, the PCB 330 and the lid member 340, and the second piezoelectric plate 310 is provided in the space. Also, the space provided by the second vibration plate 320, the PCB 330 and the lid member 340 may be a resonance space of the second piezoelectric plate 310.

The piezoelectric speaker 300 is provided on the piezoelectric vibration member 200 as described above, and the piezoelectric speaker 300 may be used as a weight body of the piezoelectric vibration member 200, that is, as a weight member. Accordingly, the weight of the piezoelectric speaker 300 is applied to the piezoelectric vibration member 200, and thus, the vibration characteristic of the piezoelectric vibration member 200 may further be improved, and the thickness of the complex device may further be reduced than in the previous exemplary embodiment.

Also, in the exemplary embodiments, the piezoelectric vibration member and the piezoelectric speaker are exemplarily described, but components accommodated in the frame are not limited to the piezoelectric vibration member and the piezoelectric speaker. For example, various sound output devices including a dynamic speaker instead of the piezoelectric speaker may be provided. Also, in addition to the piezoelectric vibration member 200 and the piezoelectric speaker 200, a pressure sensor may further be provided. A complex device further including the pressure sensor as described above in accordance with a third exemplary embodiment will be described below with reference to drawings.

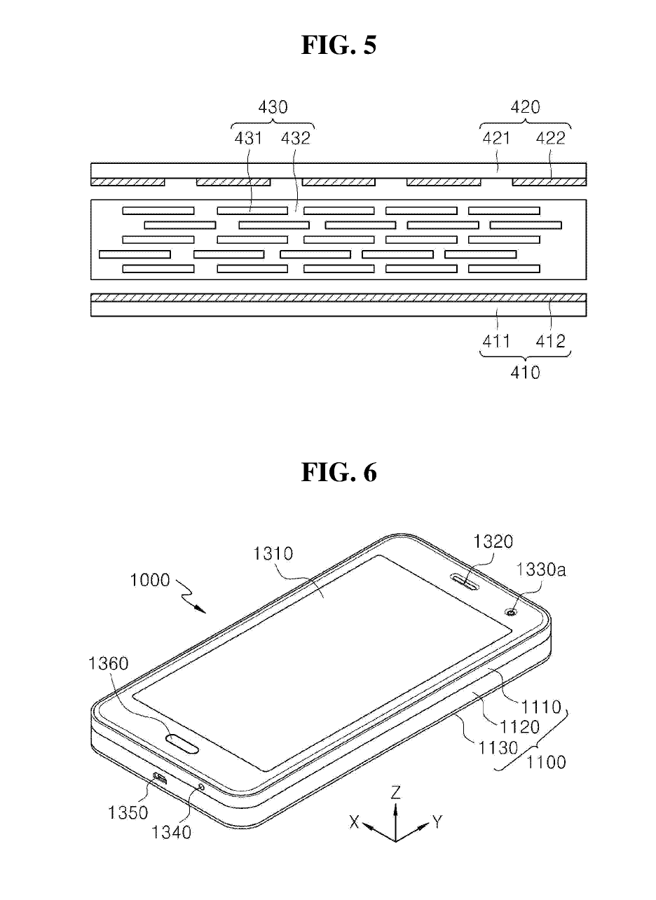

FIG. 4 is a cross-sectional view of a complex device in accordance with a third exemplary embodiment, that is, a cross-sectional view of the complex device further including a pressure sensor. Also, FIG. 5 is a cross-sectional view of a pressure sensor in accordance with an exemplary embodiment.

Referring to FIGS. 4 and 5, a complex device in accordance with a third embodiment may include a frame 100, a piezoelectric vibration member 200 and a piezoelectric speaker 300 which are provided in the frame 100, and a pressure sensor 400 provided inside or outside the frame 100. Here, since the piezoelectric vibration member 200 and the piezoelectric speaker 300 have been described in the first and second exemplary embodiments, a detailed description thereof will not be provided.

The frame 100 may include a vertical part 121 forming an exterior shape, first protrusion parts 122 inwardly protruding in a predetermined region of the vertical part 121, and second protrusion parts 123 inwardly protruding from a predetermined region of the vertical part 121 while being spaced apart from the first protruding parts 122 in the vertical direction. That is, the first and second protrusion parts 122a and 123 may be provided while being spaced apart a predetermined distance in the vertical direction inside the vertical part 121. Here, the first protrusion parts 122a may be provided to support the piezoelectric vibration member 200 and the piezoelectric speaker 300 and the second protrusion parts 123 may be provided to support the pressure sensor 400. Also, the thicknesses of the first and second protrusion parts 122a and 123 may be the same or different. For example, the first protrusion parts 122a may be formed thicker than the second protrusion parts 123. That is, since the piezoelectric vibration member 200 and the piezoelectric speaker 300 are spaced apart from each other with the first protrusion parts 122a disposed therebetween, and the first piezoelectric plate 210 is provided in a space between the first protrusion parts 122a, the thickness of the first protrusion parts 122a may be adjusted according to any one of the spacing distance between the piezoelectric vibration member 200 and the piezoelectric speaker 300 and the thickness of the first piezoelectric plate 210. However, since the second protrusion parts 123 support the pressure sensor 400 and no structure is formed between the second protrusion parts 123, the second protrusion parts 123 may be formed in a thickness smaller than that of the first protrusion parts 122a.

4. Pressure Sensor

A pressure sensor 400 may be provided on the piezoelectric vibration member 200 inside the frame 100. However, the pressure sensor 400 may be provided on the piezoelectric vibration member 200 outside the frame 100. That is, when the pressure sensor 400 has a size equal to or smaller than the size of the inside of the frame 100, the pressure sensor 400 may be provided inside the frame 100, and when the pressure sensor 400 has a size larger than the size of the frame 100, the pressure sensor 400 may also be provided over the frame 100. The pressure sensor 400 may include first and second electrode layers 410 and 420 which are spaced apart from each other, and a piezoelectric layer 430 provided between the first and second electrode layers 410 and 420. That is, the first and second electrode layers 410 and 420 are space apart from each other in the vertical direction and the piezoelectric layer 430 may be provided therebetween.

The first and second electrode layers 410 and 420 may include first and second support layers 110 and 120 and first and second electrodes 412 and 422 respectively formed on the first and second support layers 411 and 421. That is, the first and second support layers 411 and 421 are formed to be space apart a predetermined distance from each other, and the first and second electrodes 412 and 422 are respectively formed on surfaces of the first and second support layers 411 and 421. The first and second support layers 411 and 421 may be provided in a plate shape having a predetermined thickness. Also, the first and second support layers 411 and 421 may also be provided in a film shape so as to have flexibility. The first and second support layers 411 and 421 may be formed by using silicone, urethane, polyurethane, polyimide, PET, PC, or the like. Also, the first and second support layers 411 and 421 may be transparent or opaque according to a case. The first and second electrodes 412 and 422 may be formed of a transparent conductive material such as indium tin oxide (ITO) or antimony tin oxide (ATO). However, the first and second electrodes 412 and 422 may also be formed of other transparent conductive material except for the above material and may also be formed of an opaque conductive material such as silver (Ag), platinum (Pt), or copper (Cu). Also, the first and second electrodes 412 and 422 may be formed in directions crossing each other. For example, the first electrode 412 may be formed in one direction so as to have a predetermined width, and this extends so as to be spaced apart a predetermined distance in the other direction. In comparison, the second electrode 420 may be formed in the other direction perpendicular to one direction so as to have a predetermined width, and this may be formed so as to be spaced apart a predetermined distance in one direction perpendicular to the other direction. That is, the first and second electrodes 412 and 422 may be formed in directions perpendicular to each other. Of course, the first and second electrodes 412 and 422 may also be formed in various shapes other than the above shape. For example, any one of the first and second electrodes 412 and 422 may be formed entirely on the support layer, and the other one may also be formed in plurality in an approximately rectangular pattern having a predetermined width and distance in one and the other directions. Here, the first and second electrodes 412 and 422 may also be formed in directions facing each other and may be formed so as not to face each other. Also, the first and second electrodes 412 and 422 may also be formed to contact the piezoelectric layer 430 and may be formed not to contact the piezoelectric layer 430. Of course, the first and second electrodes 412 and 422 may maintain a state of being spaced apart a predetermined distance from the piezoelectric layer 430, and when a predetermined pressure, for example, a touch pressure of a user is applied, at least any one of first and second electrodes 412 and 422 may locally contact the piezoelectric layer 430. At this time, a voltage of a predetermined level may be generated from the piezoelectric layer 430.

The piezoelectric layer 430 may be provided in a predetermined thickness between the first and second electrode layers 410 and 420, for example, in a thickness of approximately 10 μm to approximately 5000 μm. That is, the piezoelectric layer 430 may be provided in various thicknesses according to sizes of electronic devices in which the pressure sensor 400 is used. For example, the piezoelectric layer 430 may be provided in a thickness of approximately 10 μm to approximately 5000 μm, favorably approximately 500 μm or less, and more favorably 200 μm or less. The piezoelectric layer 430 may be formed by using a piezoelectric body 431, which has an approximately rectangular plate shape having a predetermined thickness, and a polymer 432. That is, a plurality of plate-shaped piezoelectric bodies 431 are provided in the polymer 432, and thus, the piezoelectric layer 430 may be formed. Here, the piezoelectric body 431 may be formed by using piezoelectric materials, such as Pb, Zr, or Ti (PZT), Na, K and Nb (NKN), Bi, or Na, and Ti (BNT) based materials. Of course, the piezoelectric body 431 may be formed by using various piezoelectric materials other than the above materials. The piezoelectric body 431 having a predetermined shape may be formed in a size of approximately 3 μm to approximately 5000 μm, and a plurality of piezoelectric bodies 431 may be arranged in one and the other directions. That is, the piezoelectric bodies 431 may be arranged between the first and second electrode layers 410 and 420 in the thickness direction (that is, vertical direction) and a planar direction perpendicular to the thickness direction (that is, horizontal direction). The piezoelectric bodies 431 may be arranged in the thickness direction in at least two or more layers, for example, may be formed in a five-layer structure. Meanwhile, the piezoelectric bodies 431 favorably have the same size and are favorably spaced apart the same distance from each other. However, the piezoelectric bodies 431 may also be provided in at least two or more sizes and in at least two or more distances. Here, the piezoelectric bodies 431 may be formed in a density of approximately 30% to approximately 99% and may favorably be provided in the same density in all regions. Also, the piezoelectric bodies 431 are formed in a single crystal form to thereby have an excellent piezoelectric characteristic. That is, in comparison with the case of using piezoelectric powder, plate-shaped piezoelectric bodies 431 are used. Accordingly, a piezoelectric characteristic is excellent, a pressure may thereby be detected by even a minute touch. Thus, errors of touch inputs may be prevented. Meanwhile, the polymer 432 may include, but is not limited to, one or more polymers selected from the group consisting of epoxy, polyimide, and liquid crystalline polymer (LCP). Also, the polymer 432 may be formed of a thermoplastic resin. As a thermoplastic resin, one or more selected from the group consisting of novolac epoxy resin, phenoxy type epoxy resin, BPA type epoxy resin, BPF type epoxy resin, hydrogenated BPA epoxy resin, dimer acid modified epoxy resin, urethane modified epoxy resin, rubber modified epoxy resin, and DCPD type epoxy resin may be included.

Meanwhile, the piezoelectric layer 430 may also be formed by using not only the piezoelectric bodies 431 but also piezoelectric powder and may also be formed by using only a piezoelectric material without adding the piezoelectric bodies 431 and the polymer 432. At this time, the piezoelectric layer 430 formed of only the piezoelectric material may have a cut portion (not shown) with a predetermined depth in one and the other directions, and an elastic layer (not shown) may be formed in the cut portion. For example, the cut portion is formed, the piezoelectric layer 430 may thereby be divided into plurality having a size of approximately 10 μm to approximately 5000 μm and a spacing distance of approximately 1 μm to approximately 300 μm. That is, a unit cell may have a size of approximately 10 μm to approximately 5000 μm and a spacing distance of approximately 1 μm to approximately 300 μm. Also, the elastic layer may be formed by using polymer, silicone, or the like having elasticity.

Furthermore, as the pressure sensor 400, not only a piezoelectric pressure sensor in which the piezoelectric layer 430 is formed between the first and second electrode layers 410 and 420 but also an electrostatic pressure sensor in which a dielectric layer (not shown) is formed between the first and second electrode layers 410 and 420 may be used. That is, the pressure sensor 400 may also be an electrostatic pressure sensor in which dielectric layers are formed instead of the piezoelectric layer 430. Here, the dielectric layer may include a material having at least one among a hardness of approximately 10 or less, a plurality of pores, and a dielectric constant of approximately 4 or more and may be compressed and recovered. The dielectric layer may have a hardness of approximately 0.1 to approximately 10, may favorably have a hardness of approximately 2 to approximately 10, and may further favorably have a hardness of approximately 5 to approximately 10. For this, the dielectric layer may be formed by using, for example, silicone, gel, rubber, urethane, or the like. Here, pores may be formed in various sizes and shapes and may be formed in a pore ratio of approximately 1% to approximately 95%. In order to include a plurality of pores, the dielectric layer may include foamed rubber, foamed silicone, foamed latex, foamed urethane, or the like and may be formed of a material including pores and a compressible and recoverable material. Meanwhile, the dielectric layer may have a dielectric constant of approximately 4 or more, and for this, a dielectric body having a dielectric constant of approximately 4 or more, and favorably greater than approximately 4 may be added into the polymer. As a material having a dielectric constant of approximately 4 or more, favorably greater than approximately 4, for example, a material including at least one among Ba, Ti, Nd, Bi, Zn, or Al, such as oxides of the above materials may be used. For example, the dielectric body may be formed by using a mixture including at least one or more among BaTiO₃, BaCO₃, TiO₂, Nd, Bi, Zn, or Al₂O₃. Here, the dielectric body may be formed in a density of approximately 0.01% to approximately 95%. Meanwhile, the dielectric layer may further include a material for blocking and absorbing electromagnetic wave. As such, since an electromagnetic wave blocking and absorbing material is further included in the dielectric layer, electromagnetic wave may be blocked or absorbed. The electromagnetic wave blocking and absorbing material may include ferrite, alumina or the like, which may be contained in the dielectric layer in the range of approximately 0.01 wt % to approximately 50 wt %. That is, with respect to 100 wt % of dielectric layer material, the content of the electromagnetic wave blocking and absorbing material may be approximately 0.01 wt % to approximately 50 wt %.

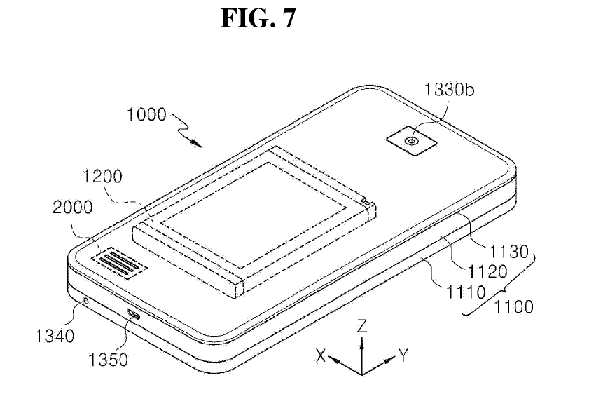

FIGS. 6 and 7 are a front perspective view and a rear perspective view of an electronic device provided with a complex device in accordance with exemplary embodiments. Here, in the exemplary embodiment, a mobile terminal including a smart phone as an electronic device provided with a complex device will be exemplarily described, and FIGS. 6 and 7 schematically illustrate exterior shapes.

Referring to FIGS. 6 and 7, an electronic device 1000 includes a case 1100 forming an exterior shape thereof and a plurality of functional modules, circuits, or the like for performing a plurality of functions of the electronic devices 1000 are provided inside the case 1100. The case 1100 may include a front case 1110, a rear case 1120, and a battery cover 1130. Here, the front case 1110 may form an upper portion and a portion of side surfaces of the electronic device 1000, and the rear case 1120 may form a portion of side surfaces and a lower portion of the electronic device 1000. That is, at least a portion of the front case 1110 and at least a portion of the rear case 1120 may form a side surface of the electronic device 1000, and a portion of the front case 1110 may form a portion of the upper surface except for the display part 1310. Also, the battery cover 1130 may be provided so as to cover a battery 1200 provided on the rear case 1120. Meanwhile, the battery cover 1130 may be integrally provided or may be provided in a detachable manner That is, when the battery 1200 is an integral type, the battery cover 1130 may be integrally formed, and when the battery 1200 is detachable, the battery cover 1130 may be also detachable. Of course, the front case 1110 and the rear case 1120 may also be integrally manufactured. That is, the case 1100 is formed such that the side surfaces and the rear surface are closed without distinction of the front case 1110 and the rear case 1120, and the battery cover 1130 may also be provided so as to cover the rear surface of the case 1100. At least a portion of the case 1100 may be formed by injection molding of a synthetic resin or may be formed of a metallic material. That is, at least a portion of the front case 1110 and the rear case 1120 may be formed of a metallic material, and for example, a portion forming the side surface of the electronic device 1000 may be formed of a metallic material. Of course, the battery cover 1130 may also be formed of a metallic material. As a metallic material used for the case 1100, for example, stainless steel (STS), titanium (Ti), aluminum (Al) or the like may be included. Meanwhile, various components, for example, a display part such as a liquid crystal display device, a pressure sensor, a circuit substrate, a haptic device, or the like may be embedded in a space formed between the front case 1110 and the rear case 1120.

In the front case 1110, a display part 1310, a sound output module 1320, a camera module 1330a, and the like may be disposed. Also, a microphone 1340, an interface 1350 and the like may be disposed on one side surface of the front case 1110 and the rear case 1120. That is, the display part 1310, the sound output module 1320, the camera module 1330a and the like may be disposed on the upper surface of the electronic device 1000, and the microphone 1340, the interface 1350, and the like may be disposed on one side surface, that is, a lower side surface of the electronic device 1000. The display part 1310 is disposed on the upper surface of the electronic device 1000 and occupies most of the upper surface of the front case 1110. That is, the display part 1310 may be provided in an approximately rectangular shape having predetermined lengths in X- and Y-directions, and may be formed in most region of the upper surface of the electronic device 1000 including a central region of the upper surface. Here, a predetermined space which is not occupied by the display part 1310 is provided between the periphery of the electronic device 1000, that is, the periphery of the front case 1110 and the display part 1310, and the sound output module 1320 and the camera module 1330a are provided on the upper side of the display part 1310 in the Y-direction in the space, and a user input part including the front face input part 1360 may be provided on the lower side of the display part 1310 in the Y-direction in the space. Furthermore, a bezel region may be provided between two edges of the display part 1310 extending in the X-direction and the periphery of the electronic device 1000, that is, between the display part 1310 and the periphery of the electronic device 1000 in the Y-direction. Of course, a separate bezel region may not be provided and the display part 1310 may be provided to extend to the periphery of the electronic device 1000 in the Y-direction.

The display part 1310 may output visual information and haptic information of a user may be input to the display part 1310. For this, the display part 1310 may be provided with a touch input device. The touch input device may include a window (not shown) for covering a front surface of the terminal body, a display part (not shown) such as a liquid crystal display device which outputs visual information, and a touch sensor to which touch information of a user Is inputted. The window is provided on the upper side of the display part and is supported by at least a portion of the front case 1310. Also, the window forms the upper surface of the electronic device and is brought into contact with an object such as a finger or a stylus. The window may be formed of a transparent material and, for example, may be manufactured by using an acryl resin, glass or the like. Meanwhile, the window may be formed on the upper surface of the electronic device 1000 not only on the display part 1310 but also on the outside of the display part 1310. That is, the window may be formed to cover the upper surface of the electronic device 1000. The display part displays an image to a user through the window and may include a liquid crystal display (LCD) panel, an organic light emitting display (OLED) panel or the like. When the display part is a liquid crystal panel, a backlight unit may be provided on the lower side of display part. The touch sensor, in which a plurality of electrodes are formed to be spaced apart a predetermined distance in one direction or the other direction perpendicular to the one direction, for example, on a transparent plate with a predetermined thickness and a dielectric layer is provided between the electrodes, may detect a touch input of a user. That is, the touch sensor in which the plurality of electrodes are arranged in a lattice shape may detect the electrostatic capacity according to the distance between the electrodes. Here, the touch sensor may detect coordinates in a horizontal direction in which a user touches the sensor in X- and Y-directions perpendicular to each other.

Meanwhile, the sound output module 1320, a camera module 1330a, and the front surface input part 1360 or the like may be disposed in regions except for the display part 1310 on the upper surface of the front case 1110. At this time, the sound output module 1320 and the camera module 1330a are provided on the upper side of the display part 1310 in the Y-direction, and the user input part such as the front surface input part 1360 may be provided on the lower side of the display part 1310 in the Y-direction. The front surface input part 1360 may be configured from a touch key, a push key, or the like, and a configuration without front surface input part 1360 may be possible by using a touch sensor or a pressure sensor. At this time, a functional module for the function of the front surface input part 1360 may be provided in a lower inner portion of the front surface input part 1360, that is, inside the case 1100 on the lower side of the front surface input part 1360 in the Z-direction. That is, according to a driving method of the front surface input part 1360, the functional module for performing the function of the touch key or the push key, and the touch sensor or the pressure sensor may be provided. Also, the front surface input part 1360 may include a fingerprint recognizing sensor. That is, the fingerprint of a user may be recognized through the front surface input part 1360, whether a user is a legal user may be detected, and for this, the functional module may include the fingerprint recognizing sensor. Meanwhile, on one and the other sides of the front surface input part 1360 in the Y-direction, a pressure sensor (not shown) may be provided. The pressure sensor is provided on both sides of the front surface input part 1360 as the user input part, and thus, a touch input of a user is detected, and the function of returning to the previous screen and a set function for setting a screen of the display part 1310 may be performed. At this time, the front surface input part 1360 using the fingerprint recognizing sensor may perform not only the fingerprint recognition of the user but also the function of returning to an initial screen.

Although not shown, a power supply part and a side surface input part may be further provided on the side surface of the electronic device 1000. For example, the power supply part and the side surface input part may be provided on two side surfaces facing each other in the Y-direction of the electronic device and may also be provided on one side surface so as to be spaced apart from each other. The power supply part may be used when the electronic device is turned on/off or when a screen is enabled or disabled. Also, the side surface input part may be used to adjust the volume of the sound output from the sound output module 1320. At this time, the power supply part and the side surface input part may be configured form a touch key, push key or the like and may be configured from a pressure sensor. That is, the electronic device in accordance with an exemplary embodiment may be provided with pressure sensors in a plurality of respective regions except for the display part 1310. For example, in order to detect inputs of the sound output module 1320 and the camera module 1330a which are on the upper side of the electronic device, and to control the pressure of the front surface input part 1360 on the lower side of the electronic device, and to control the pressures of the power supply part, the side surface input part, and the like, at least one pressure sensor may further be provided.

Meanwhile, a camera module 1330b may further be provided on the rear surface of the electronic device 1000, that is, on the rear case 1120. The camera module 1330b may have an imaging direction substantially reverse to the camera module 1330a and may be a camera having the number of pixels different from that of the camera module 1330a. A flash (not shown) may further be provided adjacent to the camera module 1330b. Also, although not shown, a fingerprint recognizing sensor may be provided below the camera module 1330b. That is, the fingerprint recognizing sensor is not provided to the front surface input part 1360 but on the rear surface of the electronic device 1000.

Also, for example, on the lower side of the battery 1200 of the electronic device 1000, a complex device 2000 in accordance with exemplary embodiments may be provided so as to be exposed through the rear case 1120 and the battery cover 1130. That is, the complex device 2000 is provided inside the electronic device 1000, and at least a portion thereof may be exposed to the outside through the rear case 1120 and the battery cover 1130. Here, a piezoelectric speaker 300 of the complex device 2000 may be exposed to the outside of the electronic device 1000. That is, a piezoelectric vibration member 200 may be provided inside the electronic device 1000 on the upper side in the Z-direction, and the piezoelectric speaker 300 is provided on the lower side. Thus, at least a portion of the piezoelectric speaker 300 may be exposed. Of course, when the pressure sensor 400 is further provided, the pressure sensor 400 may also be provided inside the electronic device 1000.

The battery 1200 may be provided between the rear case 1120 and the battery cover 1300, may be fixed, and may also be provided in a detachable manner At this time, the rear case 1120 may be formed such that in order to provide a region in which the battery 1200 is inserted, the corresponding region may be concavely formed and the battery cover 1130 covers the battery 1200 and the rear case 1120 after the battery 1200 is mounted.

As described above, the technical idea of the present invention has been specifically described with respect to the above embodiments, but it should be noted that the foregoing embodiments are provided only for illustration while not limiting the present invention. Various embodiment s maybe provided to allow those skilled in the art to understand the scope of the present invention.

1. A complex device comprising:
a frame in which a predetermined space is provided;
a vibration member provided in the frame and generating vibration; and
a speaker provided in the frame and generating a sound.

2. The complex device of claim 1, wherein the vibration member comprises a piezoelectric vibration member, and the speaker comprises a piezoelectric speaker.

3. The complex device of claim 2, wherein the frame comprises first, second, and third covers respectively covering upper, side, and lower parts thereof, wherein the second cover comprises at least one inwardly protruding protrusion part.

4. The complex device of claim 3, wherein the piezoelectric vibration member and the piezoelectric speaker are provided to be spaced apart from each other with the protrusion part disposed therebetween.

5. The complex device of claim 4, wherein the piezoelectric vibration member comprises a first vibration plate and a first piezoelectric plate provided on one surface of the first vibration plate, wherein at least a portion of the first vibration plate is provided on the protrusion part.

6. The complex device of claim 5, wherein the piezoelectric vibration member further comprises a connecting member provided between the other surface of the first vibration plate and the first cover, and the first cover is used as a weight body of the piezoelectric vibration member.

7. The complex device of claim 3, wherein the piezoelectric vibration member and the piezoelectric speaker are provided to be brought into contact with each other.

8. The complex device of claim 7, wherein the piezoelectric vibration member further comprises a connecting member provided between the other surface of the first vibration plate and the piezoelectric speaker, and the piezoelectric speaker is used as a weight body of the piezoelectric vibration member.

9. The complex device of claim 5 or 7, wherein the piezoelectric speaker comprises:
a second vibration plate;
a second piezoelectric plate provided on one surface of the second vibration plate;
a PCB provided on one surface of the second vibration plate so as to be spaced apart from the second piezoelectric plate; and
a lid member provided on the PCB.

10. The complex device of claim 9, wherein the first vibration plate and the second vibration plate are provided to be formed of different materials, and the first vibration plate is thicker than the second vibration plate.

11. The complex device of claim 9, wherein the first piezoelectric plate and the second piezoelectric plate are provided to have the same structure and material, and the first piezoelectric plate is thicker than the second piezoelectric plate.

12. The complex device of claim 2, further comprising a waterproof layer formed on at least a portion of at least any one of the piezoelectric vibration member and the piezoelectric speaker.

13. The complex device of claim 2, further comprising a pressure sensor provided inside or outside the frame.

14. The complex device of claim 13, wherein the pressure sensor comprises first and second electrode layers and a piezoelectric layer or a dielectric layer provided between the first and second electrode layers.

15. An electronic device comprising:
a case;
a window provided on an upper side in the case;
a display part provided in the case and displaying an image through the window; and
a complex device provided in the case and serving at least two or more functions, wherein the complex device comprises
a frame in which a predetermined space is provided,
a vibration member provided in the frame and generating vibration, and
a speaker provided inside the frame and generating a sound.

16. The electronic device of claim 15, wherein the vibration member and the speaker are provided to be spaced apart from each other, and a portion of the frame is used as a weight body of the vibration member.

17. The electronic device of claim 15, wherein the vibration member and the speaker are provided to be in contact with each other, and the speaker is used as a weight body of the vibration member.

18. The electronic device of claim 15, further comprising a pressure sensor provided inside or outside the frame.
